(19) United States
(12) Patent Application Publication
(10) Pub. No.: US 2016/0124904 A1
(43) Pub. Date: May 5, 2016

(54) PROCESSING DEVICE AND METHOD FOR PERFORMING A ROUND OF A FAST FOURIER TRANSFORM

(71) Applicants: Rohit TOMAR, Austin, TX (US); Aman ARORA, AUSTIN, TX (US); Maik BRETT, AUSTIN, TX (US); Deboleena SAKALLEY, AUSTIN, TX (US)

(72) Inventors: ROHIT TOMAR, EDINBURGH (GB); AMAN ARORA, DEHLI (IN); MAIK BRETT, TAUFKIRCHEN (DE); DEBOLEENA SAKALLEY, INDIRAPURAM, GHAZIABAD (IN)

(73) Assignee: Freescale Semiconductor, Inc., Austin, TX (US)

(21) Appl. No.: 14/898,803

(22) PCT Filed: Jun. 17, 2013
(86) PCT No.: PCT/IB2013/054952

§ 371 Date: Dec. 16, 2015

(51) Int. Cl. G06F 17/14

(52) U.S. Cl. CPC G06F 17/142

(57) ABSTRACT

A data processing device and a method for performing a round of an N point Fast Fourier Transform are described. The round comprises computing N output operands on the basis of N input operands by applying a set of N/P radix-P butterflies to the N input operands, wherein P is greater or equal two and the input operands are representable as N/(M*P)̂2 input operand matrices, wherein M is greater or equal one, each input operand matrix is a square matrix with M*P lines and M*P columns, and each column of each input operand matrix contains the input operands for M of said butterflies.

### FIELD OF THE INVENTION

This invention relates to a processing device and to a method for performing a round of a Fast Fourier Transform.

### BACKGROUND OF THE INVENTION

The Discrete Fourier Transform (DFT) is a linear transformation that maps a sequence of N input numbers X1 to XN (linear operands) into a corresponding set of N transformed numbers (output operands). A Fast Fourier Transform (FFT) is a processing scheme for carrying out a DFT numerically in an efficient manner. The Cooley-Tukey algorithm is probably the most widely-used FFT algorithm. It transforms the input operands in a sequence of several rounds. Each round is a linear transformation between a set of input operands and a corresponding set of output operands. The output operands of a given round may used as the input operands of the next round, until the final output operands, i.e., the DFT of the initial input operands, are obtained. Each of these linear transformations may be represented by a sparse matrix and therefore can be carried out rapidly. The DFT can thus be represented as a product of sparse matrices.

Each round of the FFT may involve the evaluation of so-called butterflies. A radix P butterfly is a linear transformation between P input operands and P output operands. In each round, the N input operands may be partitioned into N/P sets of input operands. Each of these sets may be transformed individually, i.e., not dependent on the other sets of input operands, by means of the radix P butterfly. While the butterfly may be the same for each subset of input operands and for each round, the partitioning of the set of N input operands into the N/P subsets is generally different for each round.

The left part of FIGS. 1, 2, 3, and 4 (“Previous approach”) schematically illustrates an example of a first round of an FFT of order N=128, i.e., a FFT on a set of 128 input operands. In the Figures, the input operands are numbered 0 to 127. As mentioned above, the set of input operands may be partitioned into N/P subsets, and a radix P butterfly may be applied to each of the subsets. In the example of FIG. 1, P equals 4. The 128/4=32 butterflies are schematically represented in the column “Radix schedule order”. For example, a first subset of input operands may comprise the operands labelled 0, 32, 64, and 96. A second subset may comprise the input operands labelled 8, 40, 72, and 104. The other subsets are evident from the Figure. For example, the third subset may comprise the operands labelled 16, 48, 80, and 112. Each operand may be complex valued. The values of the operands are not shown in the Figures. The values of the operands may, of course, differ from one run of the FFT to the other. The output operands of the round in question are conveniently labelled as the input operands, i.e., 0 to 127 in the present example. The output operands of the round illustrated in FIG. 1 are not necessarily the final output operands of the FFT, as the round shown is not necessarily the final round of the FFT. The scheme illustrated on the left of FIG. 1 may, for example, be the first round of the FFT.

Each input operand may be stored at an addressable memory cell. Similarly, each output operand of the round may be stored at an addressable memory cell. A memory cell or a buffer cell may also be referred to as a memory location or a buffer location, respectively. Conveniently, the input operands may be stored at input memory cells labelled 0 to 127 in the present example. Similarly, the output operands 0 to 127 may be written to output memory cells labelled 0 to 127. In other words, the I-th input operant (I=0 to 127) may be provided at the I-th input memory cell. The I-th output operant (I=0 to 127) may be written to the I-th output memory cell.

As noted above, the partitioning of the set of input operands into subsets corresponding to butterflies may, in general, be different for different rounds of the FFT. The butterflies of a given round may be executed independently from one another, sequentially, or in parallel. In the example of FIG. 1, pairs of butterflies may be executed sequentially. The two butterflies of each pair may be executed in parallel. For example, the two butterflies labelled 0 may be executed first. The two butterflies labelled 1 may be executed next, and so on. The two butterflies labelled 15 may be executed as the last butterflies of the round. In this example, executing the first two butterflies, i.e., the two butterflies labelled 0 requires the input operands 0, 32, 64, and 96 (for the first butterfly) and the input operands 8, 40, 72, and 104 (for the second butterfly). However, the input operands may be stored conveniently in a memory unit in accordance with their numbering. In other words, the input operands 0 to N−1 may be conveniently stored in a memory unit at memory locations with addresses ordered in the same manner as the input operands. For instance, input operand 0 may be stored at address 0. Input operand may be stored at address 1, and so on. The input operands required for a certain butterfly, e.g., the input operands 0, 32, 62, and 96 for the first butterfly in the left part of FIG. 1, can, in this case, not be read as a block from the memory unit. Instead, the input operands may have to be read individually from non-contiguous memory locations before the respective butterfly can be applied on them.

### SUMMARY OF THE INVENTION

The present invention provides a processing device and method for performing a round of a Fast Fourier Transform as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIGS. 1 to 4 schematically illustrate a first and a second example of a radix schedule order.

FIG. 5 schematically illustrates an example of an operand storage scheme.

FIG. 6 schematically illustrates an example of subsets of operands corresponding to a sequence of radix P=4 butterflies, for N=64.

FIG. 7 schematically illustrates an example of a scheme for defining a sequence of input operands for butterflies of FFTs with different numbers of operands.

FIG. 8 schematically illustrates the sequences of input operands resulting from the scheme of FIG. 7.

FIG. 9 schematically illustrates an example of two matrices of input operands as may be retrieved from a memory unit.

FIG. 10 schematically illustrates an example of matrices of operands as may be retrieved from a memory unit for N=512.

FIG. 11 schematically illustrates an example of an embodiment of an FFT processing device.

FIG. 12 schematically illustrates an example of an embodiment of a method of reading input operands from a memory unit.

FIG. 13 schematically illustrates another example of an embodiment of a method of retrieving input operands from a memory unit.

FIG. 14 shows a flow chart of an example of an embodiment of a method of reading input operands from a memory unit.

FIG. 15 shows a flow chart of an example of an embodiment of a method of generating a read address for reading a line of an input operand matrix from a memory unit.

FIG. 16 shows a flow chart of an example of an embodiment of a method of generating a read address for reading a line of an input operand matrix from a memory unit.

FIGS. 17 to 20 schematically illustrate an example of an embodiment of a method of storing input operands in an input buffer.

### DETAILED DESCRIPTION OF THE PREFERRED EMBODIMENTS

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

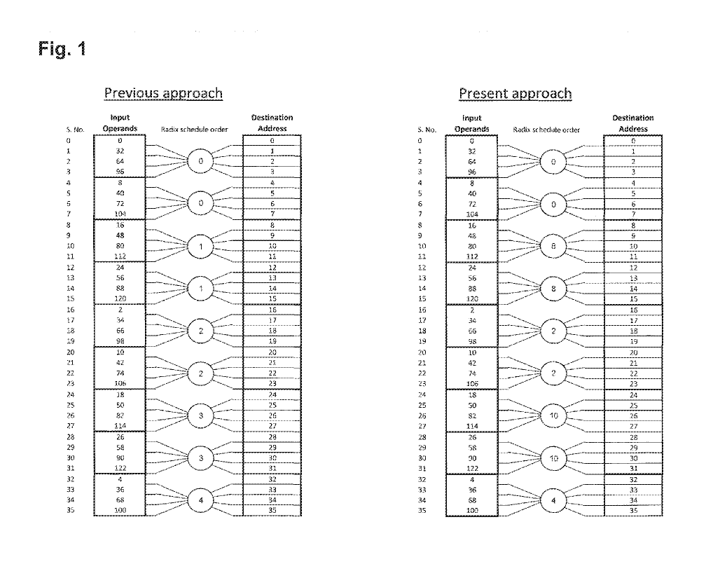

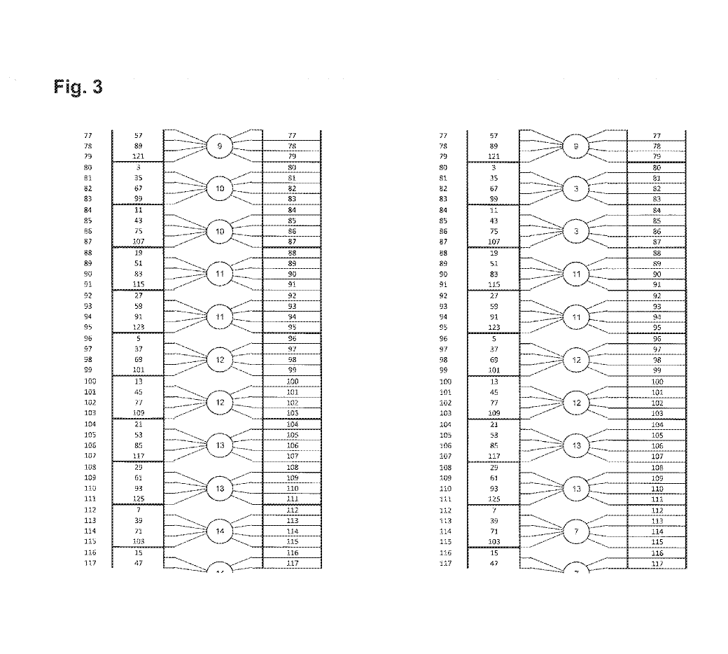

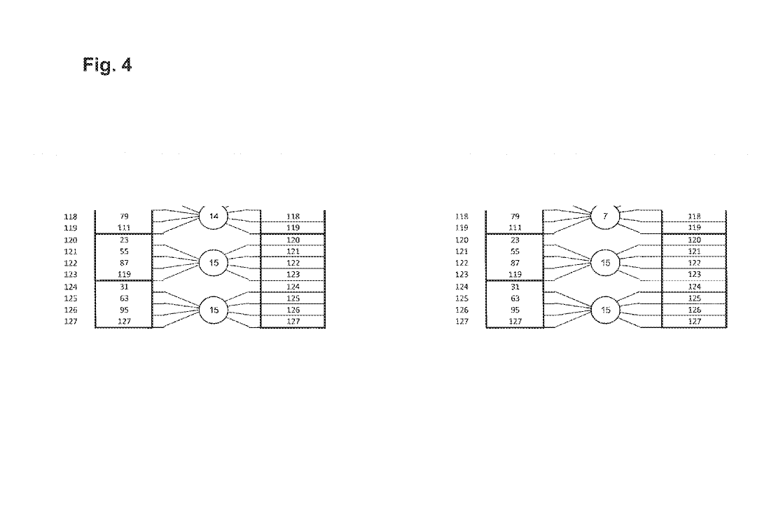

Referring now the diagram on the right side of FIGS. 1 to 4, an alternative approach (“Present approach”) for transforming the input operands is described. The present approach is mathematically equivalent to the previous approach described above in reference to the left part of FIGS. 1 to 4 but may have a few technical benefits. The previous approach (left sides of FIGS. 1 to 4) and the present approach (right side of FIGS. 1 to 4) may differ from each other, amongst others, in their radix execution orders, i.e., the orders in which the N/P butterflies are executed. It is recalled that in the present example N=128 and P=4. In other words, there are, e.g., a total of N=128 operands partitioned into N/P subsets, each subset consisting of P=4 operands to be transformed by the same butterfly. In the present example, there are thus a total of 128/4=32 butterflies.

An alternative radix execution order, i.e., an order in which they may be executed, is indicated in FIGS. 1 to 4, right side, by the numbers inside the circles of the individual butterflies. In this example, the two butterflies labelled 0, i.e., the ones acting on the input operands 0, 32, 64, 96, 8, 40, 72, and 104, are executed first in this example. The two butterflies labelled 2, i.e., the two butterflies acting on the input operands 2, 34, 66, 98, 10, 42, 74, and 106, are executed next. The last two butterflies to be executed are the ones labelled 15, acting on the input operands 23, 55, 87, 119, 31, 63, 95, and 127. This modified radix schedule order is chosen so as to allow processing blocks of successive input operands, e.g., input operands 0 to 7, with a minimum latency. The proposed radix schedule order may become most beneficial when used in conjunction with a particular scheme for reading and buffering the input operands before they are transformed into the corresponding output operands in accordance with the shown butterflies. This will be explained by making additional reference to the next figures.

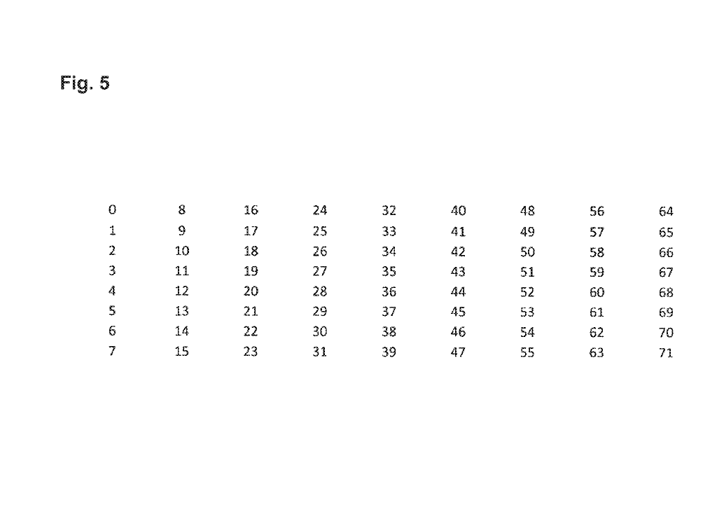

FIG. 5 schematically illustrates an example of a memory unit containing the input operands 0 to 71, for example. A memory unit containing input operands may be referred to as an input operand memory unit. The memory unit may be arranged to allow reading the input operands in blocks of, e.g., eight operands. Each block may contain a sequence of successive operands. In the Figure, these blocks are shown as columns. In the present example, a first block may comprise operands 0 to 7, a second block may comprise operands 8 to 15, and so on. The memory may, for instance, be arranged to read each block of input operands in a single clock cycle. It may thus take the memory unit nine clock cycles to read the nine blocks shown in the Figure.

For example, in a first clock cycle, the first column in FIG. 5 may be read. Operands 0 to 7 may thus be made available for further processing, namely to serve as input data of eight separate radix-four transformations (P=4). On the other hand, the operands 0 to 7 alone are insufficient for performing any of these single radix-four computations. For example, the butterfly associated with the input operands 0, 32, 64 and 96 (see again FIG. 1) requires these four input operands 0, 32, 64, and 96 at the same time.

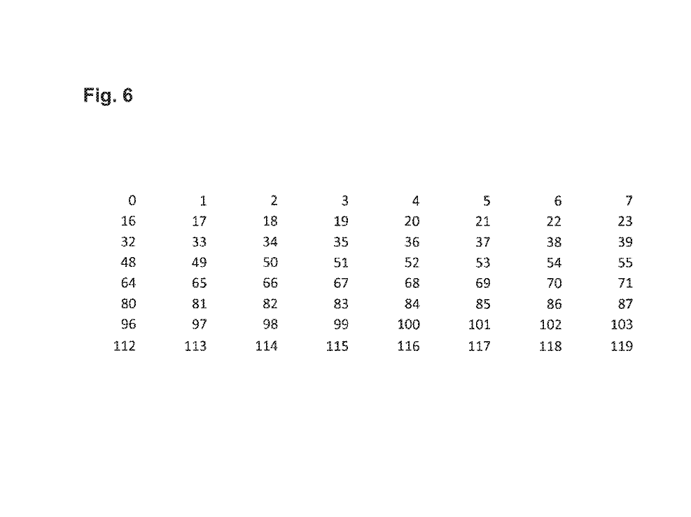

For instance, in the case of N=64, the input operands may be required in the order illustrated by FIG. 6. In this example, a first pair of radix-four butterflies may require the input operands 0, 16, 32, 48, 64, 80, 96, and 112 (first column in FIG. 6). Similarly, a second pair of radix-four butterflies may require the input operands 1, 17, 33, 49, 65, 81, 97, and 113. The remaining columns in the Figure indicate the required values for the subsequent pairs of butterflies to be executed. However, it may be impossible to read any of these subsets of input operands within a single clock cycle from the input operands memory unit. For example, the input operands may be readable from the memory unit only in blocks of, e.g., eight successive input operands. In this case, input operands 0 to 7 may be read from the memory unit in a first read operation. Input operands 16 to 23 may be read in a second read operation. Input operands 32 to 39 may be read in a third read operation, and so on. Each read operation may be performed within a single clock cycle.

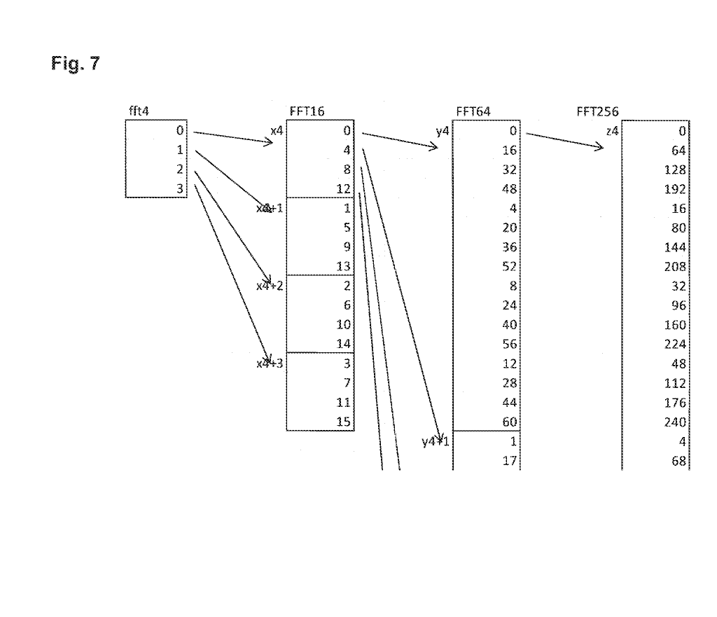

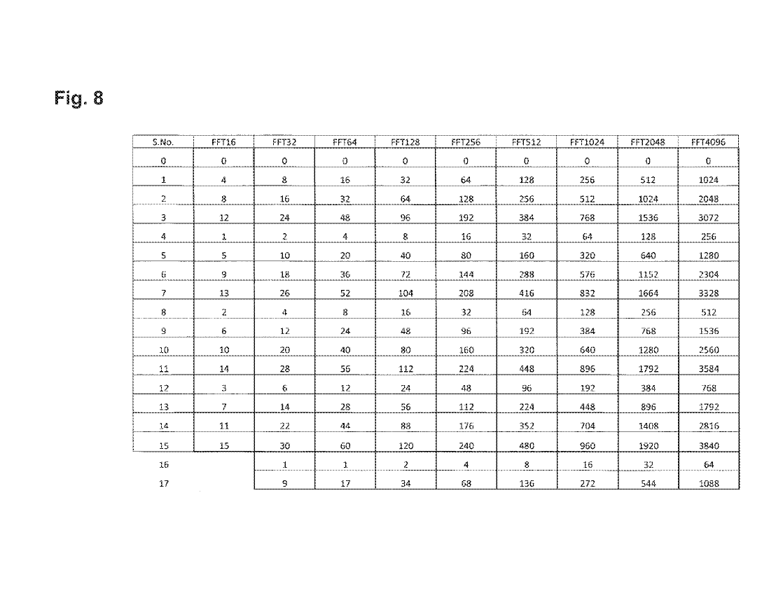

An example of a scheme for determining the required order of input operands for different values of N is indicated in FIG. 7. Sequences of input operands as may be required for various values of N are shown in FIG. 8, for N=2^{Q} with Q=4 to 12.

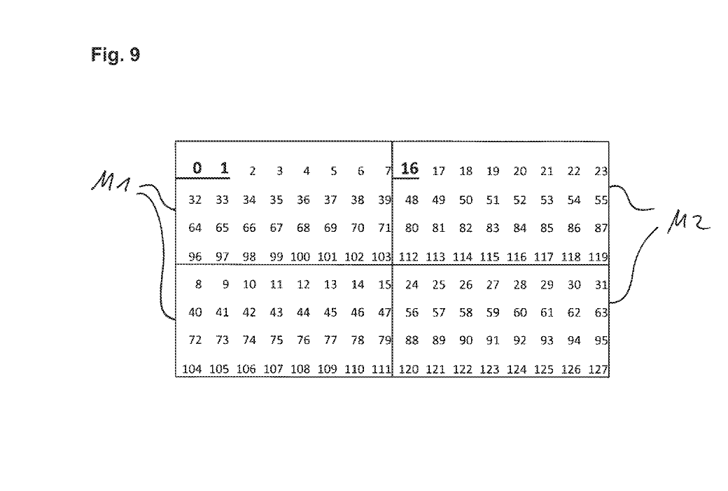

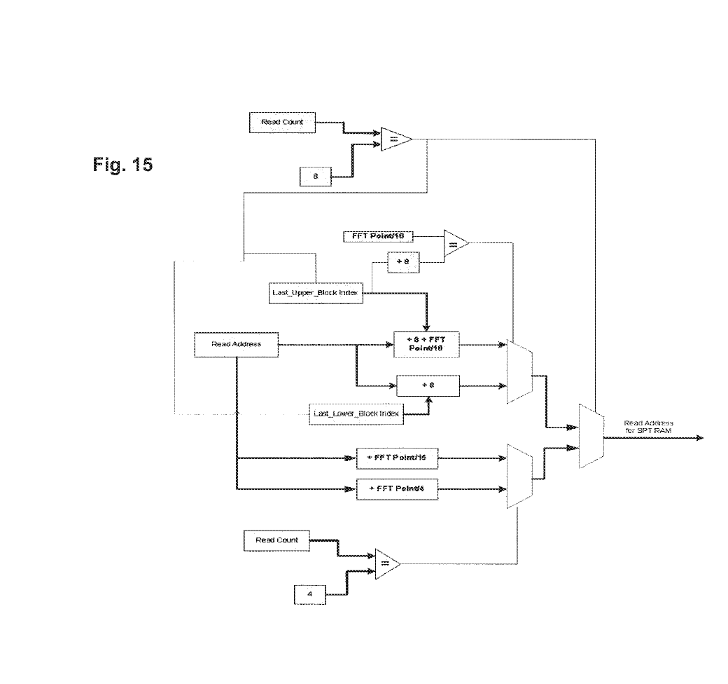

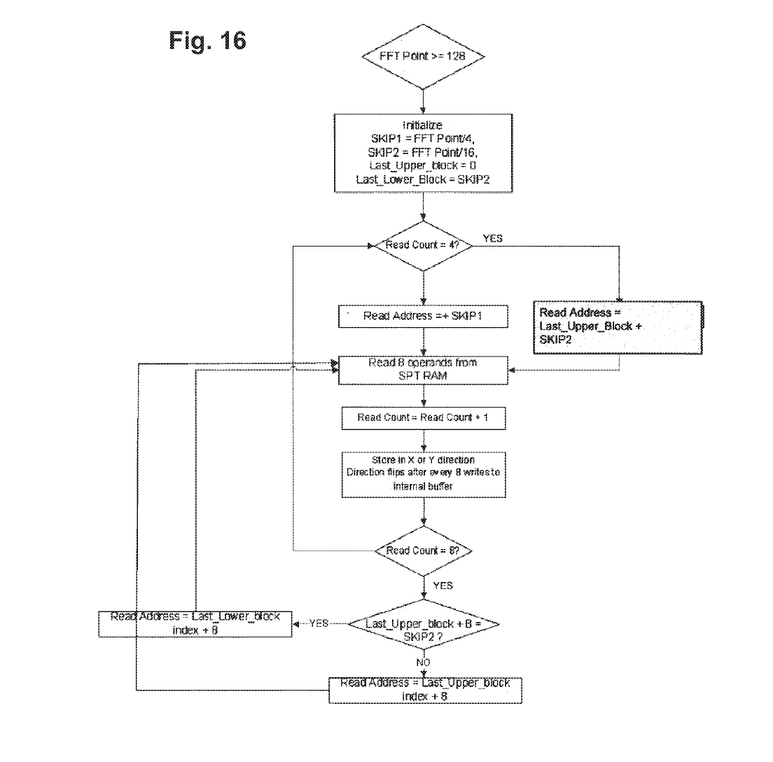

FIG. 9 illustrates an example of a possible partitioning of the set of N input operands for the case of N=128. It is recalled that the numbers shown are the indices or labels of the operands, not their values, e.g., the number “0” indicates the input operand number 0. These operands were originally placed in the memory unit, e.g., an SRAM unit, as shown in FIG. 5 described above. The arrangement shown in present FIG. 9 may, for example, be achieved by reading them from the input memory unit to a buffer in accordance with a particular reading scheme. An example of a possible reading scheme is illustrated by the flowcharts of FIGS. 15 and 16.

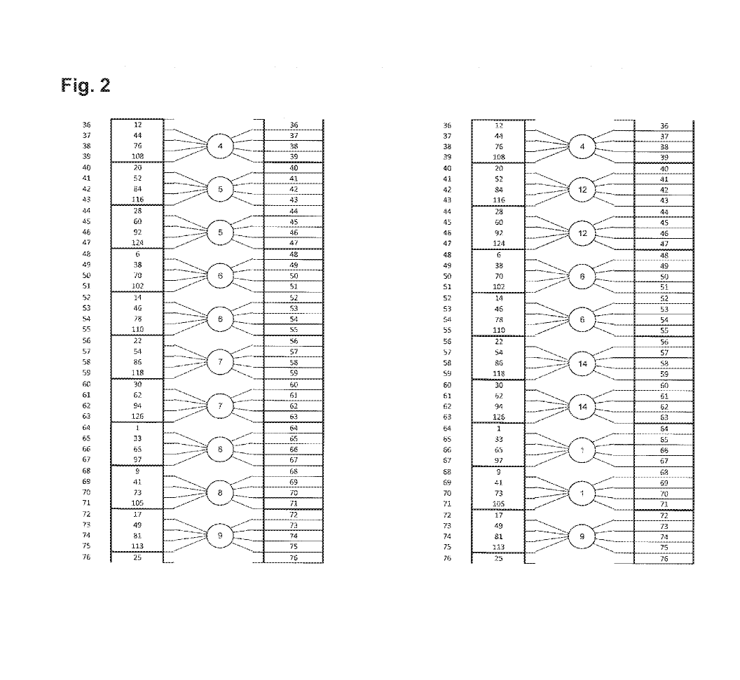

Each input operand may have a certain real or, more generally, complex value. In the shown example, the 128 input operands are arranged in a first matrix M1 and a second matrix M2. M1 may comprise, for example, the input operands 0 to 7, 32 to 39 . . . 104 to 111. M2 may comprise, e.g., the input operands 16 to 23, 48 to 55 . . . 122 to 127. The matrices containing the input operands may also be referred to as the input operand matrices. Each input operand matrix may be arranged such that each of its lines may be read as a single block from, e.g., a memory unit. The memory unit may, for example, be a Static Random Access Memory (SRAM) unit. For instance, when the input operands are stored in the memory unit at consecutive locations in accordance with their numbering, each line of each input operand matrix may contain a sequence of consecutive input operands, as shown in the Figure. For instance, each of the eight lines of matrix M1 may be read in, e.g., a single clock cycle. The same may apply analogously to the second matrix M2. In the present example, each of the two matrices M1 and M2 may thus be read in, e.g., a total of eight clock cycles. Conveniently, each column of each of the matrices contains the input operands required as input data for a certain clock cycle of these eight clock cycles. Comparing FIGS. 1 to 4 and FIG. 9, it is seen that each column of the two matrices M1 and M2 contains the input operands for a pair of radix-four butterflies. For instance, the first column of M1, i.e., 0, 32, 64, 96, 8, 40, 72, and 104, may represent the input data for the first pair of butterflies to be executed in the scheme of FIGS. 1 to 4. Similarly, the second column of matrix M1 may represent the input data for the second pair of butterflies to be executed (see FIG. 2).

Conveniently, each of the input operand matrices is a square matrix, i.e., a matrix that has as many columns as lines. Reading a single line may take one clock cycle. Furthermore, processing a single column, i.e., computing the corresponding column of output operands, may also take a single clock cycle. For example, reading a set of, e.g., eight operands from the memory unit, e.g., an SRAM unit (see FIG. 5) may take one clock cycle and may be possible in the vertical direction only. The input buffer on the other hand may comprise a set of (M*P)̂2 individually addressable buffer cells. Each cell may be capable of buffering one input operand. The input buffer may be implemented, for example, in flops. Any location in the input buffer may be accessible (to read or write) in one clock cycle.

The matrices may thus be processed efficiently in an overlapping or interlaced manner. Notably, when a first matrix, e.g., M1, has been read from an input operand memory unit and been buffered, the columns of the matrix may be transformed one by one with, e.g., one column per clock cycle. At the same time, the lines of the next matrix, e.g., M2, may be read from the input operand memory unit and buffered. Accordingly, the transformation of the I-th column of a given operand matrix, e.g., M1, and the retrieval of the I-th line of the next operand matrix, e.g., M2, from the input operand memory unit may be effected in parallel, e.g., within a single clock cycle.

The transformed matrices may be written to an output buffer. It is noted that when an operand matrix had been transformed, it may be replaced by the second next matrix (in a scenario in which there are more than two matrices). For example, the matrices may be read, buffered, and processed in accordance with the following scheme with input operand matrices M1, M2, M3. Buffer the matrix M1 in an input buffer A; process M1 and, at the same, time, buffer M2 in an input buffer B; process M2 and, at the same time, buffer M3 in input buffer A; buffer M4 in input buffer B and, at the same time, process M3. It is noted that the total number of input operand matrices may depend on the total number N of operands, the radix order P, and on the number of butterflies that are executed in parallel. The input operand matrices may thus be buffered by alternating between the two buffers.

In another example, a single input buffer may be used. The size of the single input buffer should match the size of a single operand matrix (but the buffer may, of course, be integrated in a larger buffer not further considered herein). The input buffer may be represented as a matrix (referred to herein as the buffer matrix) of the same dimension as the input operand matrices. The M*P lines and M*P columns of the buffer matrix may be referred to as the buffer lines and the buffer columns, respectively. A first operand matrix may be written to the buffer matrix by filling buffer lines with lines of the first input operand matrix. The first operand matrix may then be read, column by column, from the respective buffer columns. When a column of the first operand matrix has been read from the corresponding buffer column in order to be further processed, the respective buffer column may be filled with a line of the next (the second) input operand matrix. The second input operand matrix may thus be written to the buffer matrix by filling buffer columns (not buffer lines) successively with lines of the second input operand matrix. The next (i.e. the third) input operand matrix may again be written to the input buffer in the same manner as the first input operand matrix, namely by writing lines of the third input operand matrix to corresponding buffer lines (not buffer columns). Successive input operand matrices may thus be written to the input buffer one after the other by adapting the buffer write direction, i.e. either vertical (columnwise) or horizontal (linewise), to the buffer read direction of the respective preceding input operand matrix. This alternating scheme makes good use of the memory space provided by the input buffer and may avoid the need for a second input buffer.

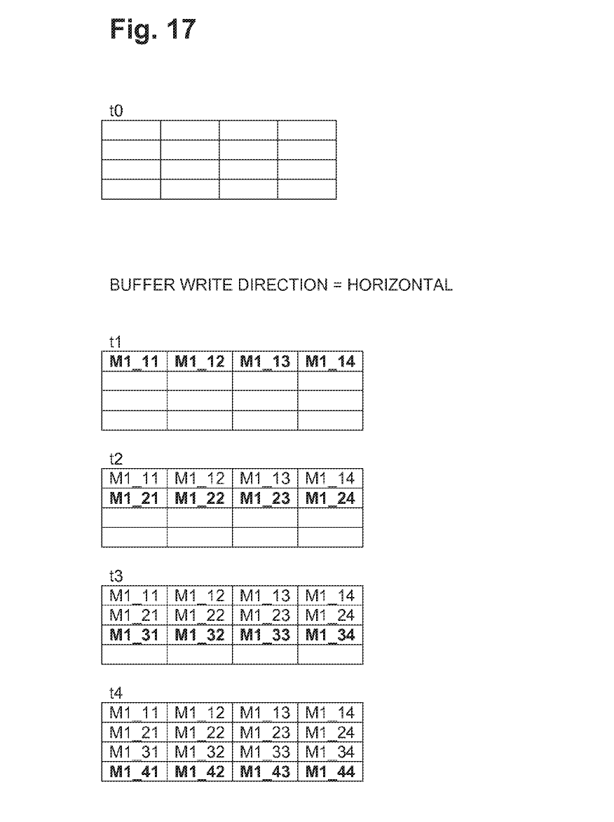

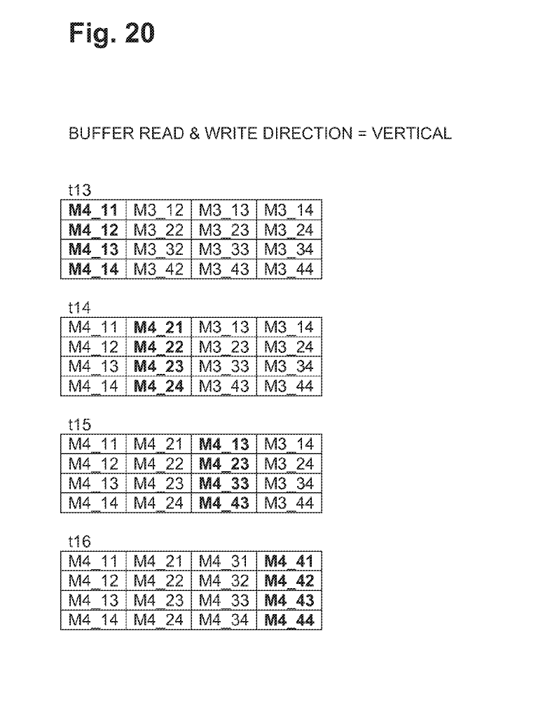

FIGS. 17 to 20 schematically illustrate an example of a method of writing input operands to an input buffer, for an example in which N=64 (i.e. there are 64 operands), M=1 (i.e. only one butterfly is processed at a time) and P=4 (i.e. the FFT makes use of radix-4 butterflies). In this example, the input operands are arranged in four input operand matrices M1 to M4, each matrix being of dimension 4 by 4. The figures show snapshots of the input buffer at consecutive instants t0 to t16. These instants may belong to consecutive clock cycles.

At time t0, the input buffer may be empty or contain data from, e.g., a previous round of the FFT (see FIG. 17).

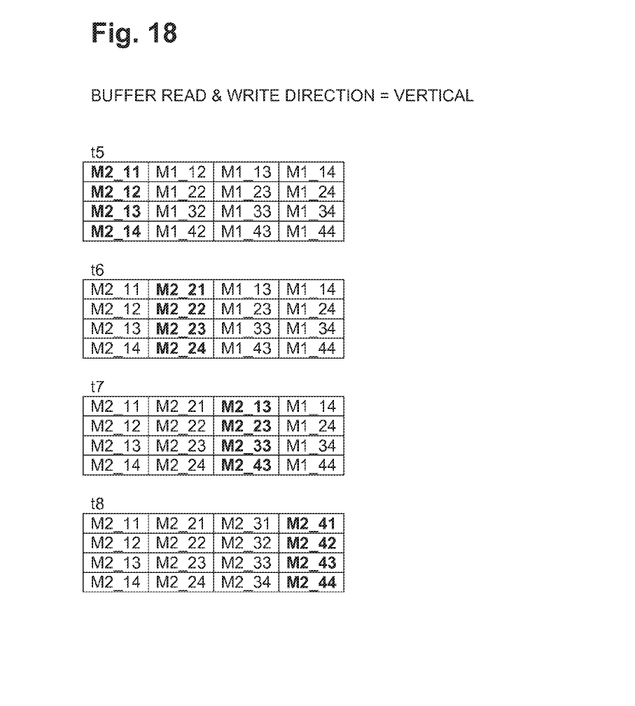

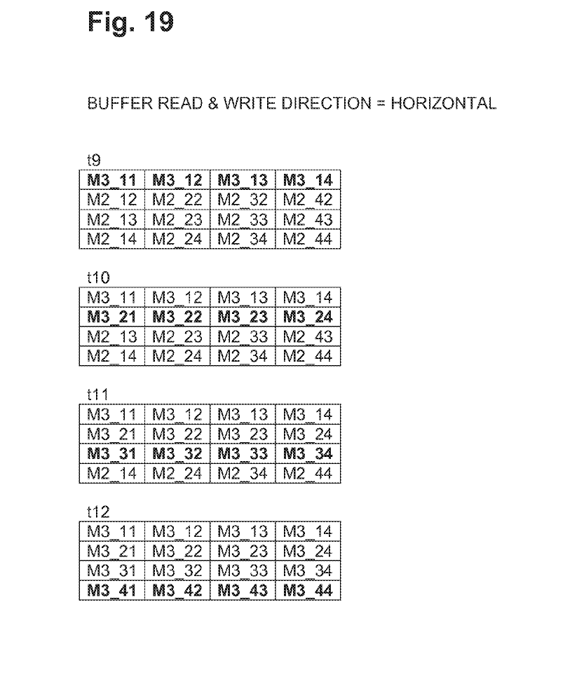

By time t4, the first, second, third, and fourth lines of the first input operand matrix M1 have been written to corresponding lines of the input buffer (see FIG. 17). By time t8, the first, second, third, and fourth lines of the second input operand matrix M2 have been written to corresponding columns of the buffer (see FIG. 18). By time t12, the first, second, third, and fourth lines of the third input operand matrix M3 have been written to corresponding lines of the buffer (see FIG. 19). By time t16, the first, second, third, and fourth lines of the fourth input operand matrix M4 have been written to corresponding columns of the buffer (see FIG. 19).

At time t4, the first column (M1_11, M1_21, M_1_31, M1_41)̂T of the first operand matrix M1 may be read from the input buffer and processed, e.g., fed to a radix-4 execution unit. At time t5, the second column (M1_12, M1_22, M_1_32, M1_42)̂T of the first operand matrix M1 may be read from the buffer and processed, e.g., fed to the radix-4 execution unit. At time t6, the third column (M1_13, M1_23, M_1_33, M1_43)̂T of the first operand matrix M1 may be read from the buffer and processed, e.g., fed to the radix-4 execution unit. At time t7, the fourth column (M1_14, M1_24, M_1_34, M1_44)̂T of the first operand matrix M1 may be read from the buffer and processed, e.g., fed to the radix-4 execution unit.

At time t8, the first column (M2_11, M2_21, M_1_31, M2_41)̂T of the second operand matrix M2 may be read from the input buffer and processed, e.g., fed to a radix-4 execution unit. At time t9, the second column (M2_12, M2_22, M_1_32, M2_42)̂T of the second operand matrix M2 may be read from the buffer and processed, e.g., fed to the radix-4 execution unit. At time t10, the third column (M2_13, M2_23, M_1_33, M2_43)̂T of the second operand matrix M2 may be read from the buffer and processed, e.g., fed to the radix-4 execution unit. At time t11, the fourth column (M2_14, M2_24, M_1_34, M2_44)̂T of the second operand matrix M2 may be read from the buffer and processed, e.g., fed to the radix-4 execution unit.

At time t12, the first column (M3_11, M3_21, M_1_31, M3_41)̂T of the third operand matrix M3 may be read from the input buffer and processed, e.g., fed to a radix-4 execution unit. At time t13, the second column (M3_12, M3_22, M_1_32, M3_42)̂T of the third operand matrix M3 may be read from the buffer and processed, e.g., fed to the radix-4 execution unit. At time t14, the third column (M3_13, M3_23, M_1_33, M3_43)̂T of the third operand matrix M3 may be read from the buffer and processed, e.g., fed to the radix-4 execution unit. At time t15, the fourth column (M3_14, M3_24, M_1_34, M3_44)̂T of the third operand matrix M3 may be read from the buffer and processed, e.g., fed to the radix-4 execution unit.

At time t16, the first column (M4_11, M4_21, M_1_31, M4_41)̂T of the fourth operand matrix M4 may be read from the input buffer and processed, e.g., fed to a radix-4 execution unit. At time t17 (not shown), the second column (M4_12, M4_22, M_1_32, M4_42)̂T of the fourth operand matrix M4 may be read from the buffer and processed, e.g., fed to the radix-4 execution unit. At time t18 (not shown), the third column (M4_13, M4_23, M_1_33, M4_43)̂T of the fourth operand matrix M4 may be read from the buffer and processed, e.g., fed to the radix-4 execution unit. At time t19 (not shown), the fourth column (M4_14, M4_24, M_1_34, M4_44)̂T of the fourth operand matrix M4 may be read from the buffer and processed, e.g., fed to the radix-4 execution unit.

Considering that M radix-P butterflies are executed in parallel, wherein M is a natural number greater or equal to 1, each column of each input operand matrix may contain M times P input operands. Each of the input operand matrices may thus have M time P lines and M time P columns. Accordingly, the set of input operands may be partitioned into a total of N/(M*P)̂2 input operand matrices. The circumflex, i.e. the symbol “̂”, means “to the power of”. In the example shown in FIG. 9, N=128, P=4, and M=2. Accordingly, the 128 input operands are partitioned into 128/64=2 input operand matrices, namely M1 and M2.

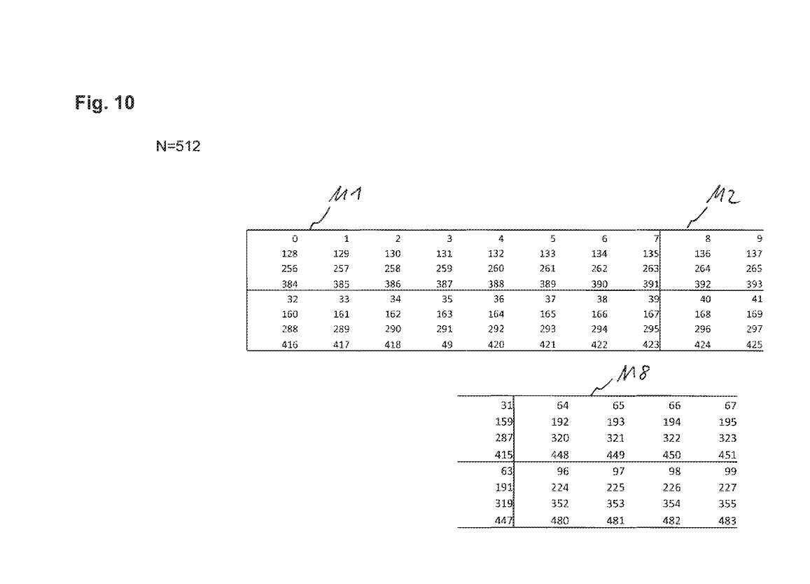

Referring now to FIG. 10, a possible partition of the input operands is illustrated for the case in which N=512, P=4, and M=2. In this case, the input operands may be partitioned into 512/64=8 square matrices M1 to M8.

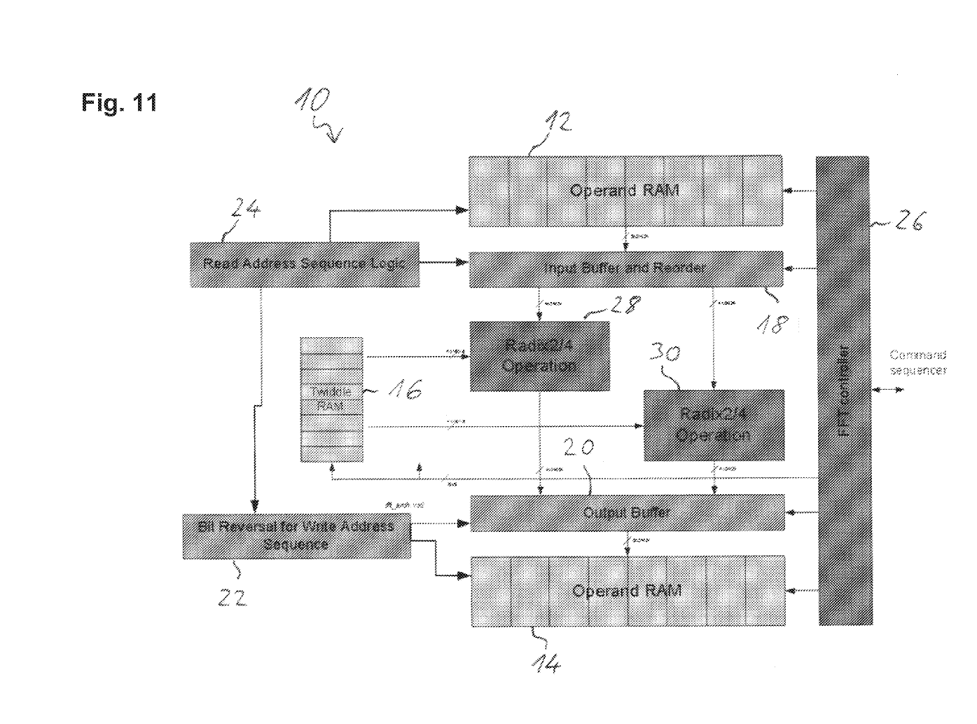

FIG. 11 schematically shows an example of an embodiment of a processing device 10 for performing a Fast Fourier Transform (FFT). The device 10 may comprise, for example, an input operand memory unit 12, an output operand memory unit 14, a coefficient memory unit 16, an input buffer 18, an output buffer 20, a bit reversal unit 22, a read address sequence unit 24, and a control unit 26. The device 10 may be arranged to operate, for example, as follows. A set of N operands may be loaded, e.g., to the operand memory unit 12 from, e.g., a data acquisition unit (not shown), which may be suitably connected to the input operand memory unit 12. The input operand memory unit 12, e.g., may be a random access memory unit (RAM), e.g., a static RAM (SRAM). The operands in the memory unit 12 are not necessarily addressable individually. Instead, only groups of input operands may be addressable individually. Each group may consist of M*P operands. In the shown example, M=2 and P=2 or P=4. A single address may be assigned to a group of M*P operands. For example, M*P=8. Operands 1 to 7 may then form a first addressable group of operands. Operands 8 to 15 may form a second addressable ground of operands, and so on. The read address sequence unit 24 may be arranged to generate the respective addresses of the operands that are to be retrieved from the input operand memory unit 12. The respective groups of operands may thus be read from the input operand memory unit 12 and stored in the input buffer 18. If necessary, the operands may be reordered. The operands may, for instance, be reordered in a first round of the FFT or, alternatively, in a last round of the FFT.

Each group of M*P input operands, e.g., stored under a single address in the input address memory unit 12, may form a single line of one of the input operand matrices described above. Each line of each input operand matrix may thus be available as an addressable group of input operands in the input operand memory unit 12. When a complete input operand matrix has been buffered in the input buffer 18, it may be transformed into a corresponding output operand matrix by one or more radix P butterflies. These butterflies may be effected in parallel. For instance, in the shown example, there are two radix P operation units 28 and 30. The radix P may, for example, be 2, 4, or 8, or any other possible radix. The radix P operation units 28 and 30 may be identical. The first radix P operation unit 28 may be arranged to effect a first radix P butterfly on a first subset of operands in a current column of the input operand matrix available in the input buffer 18. The second radix P operation unit 30 may, at the same time, effect the same radix P butterfly on a second subset of input operands on the same column of the input operand matrix available in the input buffer 18. In a variant of the shown device 10, the radix P operation units 28 and 30 may be substituted by a single radix P operation unit or by more than two radix P operation units.

Each input operand matrix may thus be read line by line from the input operand memory unit 12 and transformed column by column by means of the one or more radix P operation units, e.g., the radix P operation units 28 and 30. Each column of the input operant matrix may notably be transformed within a single clock cycle. At the same time, i.e., within the same clock cycle, a line of a next input operand matrix may be read from the input operand memory unit 12.

Each transformed column of the input operand matrix may be written as an output operand column into the output buffer 2. The output operand matrix may thus be collected in the output buffer 20. When a complete output operand matrix has been collected, e.g., column by column, in the output buffer 20, the output operand matrix may be written, e.g., line by line, to the output operand memory unit 14.

The above-described operations may be repeated similarly for each input operand matrix. In the present example, each line of the respective output operand matrix may be written at an address of the output operand memory unit 14 generated by a bit reversal operation from the original input operand memory address. In other words, a line of M*P input operands from an input address characterizing a location in the input operand memory unit 12 may be transformed into a corresponding line of M*P output operands and saved to a location in the output operand memory unit 14 specified by a write address that is bit reversed input address. As described above, each line of input operands is not transformed individually but as part of a square input operand matrix, wherein the input operand matrix may be transformed column by column. The write addresses, i.e., the bit reversed read addresses, may be generated from the corresponding read addresses by means of the bit reversal unit 22. The constant coefficients required for each radix P butterfly may be stored in the coefficient memory unit 16 and read therefrom from the radix P operation units 28 and 30, for example. The various read and write operations in the processing device 10 may be controlled at least in part by the control unit 26.

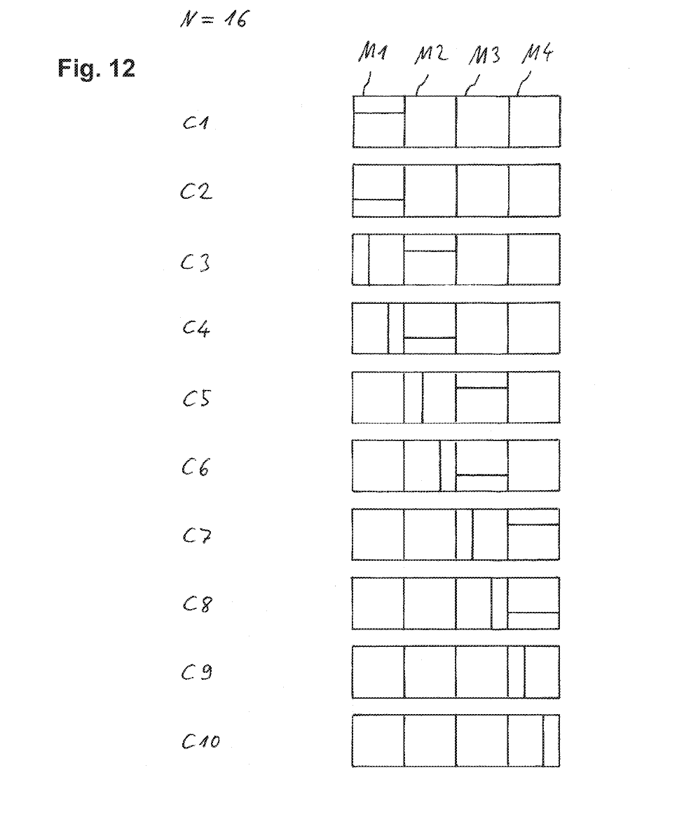

An example of the proposed processing scheme is further described in reference to FIG. 12. In this example, N=16, P=2, and M=1. The 16 operands may thus be arranged in four matrices M1, M2, M3, and M4. FIG. 12 schematically illustrates the read operations and the butterfly operations effected on the matrices M1 to M4 in a series of clock cycles C1 to C10. Each horizontal line shown within any one of the matrices M1 to M4 indicates that the respective line is being read in the respective clock cycle. For instance, in the first clock cycle, the first line of M1 may be read. In the second clock cycle C2, the second line of M1 may be read. Each vertical line within any one of the matrices M1 to M4 indicates that the corresponding column of the respective matrix is transformed by a butterfly operation in the respective clock cycle. For instance, the first column of M1 may be transformed in clock cycle C3. As may be gathered from the Figure, the matrices M1, M2, M3, M4 may be read sequentially. In the shown example, M1 is read in clock cycles C1 and C2, M2 is read in C3 and C4, M3 is read in C5 and C6, and M4 is read in C7 and C8. The matrices M1 to M4 may also be processed, i.e., transformed, sequentially. In the shown example, M1 is processed in C3 and C4, M2 is processed in C5 and C6, M3 is processed C7 and C8, and finally, M4 may be processed in C9 and C10.

It is noted that the present example of N=16 may be of little practical interest and is described here mainly for the purpose of illustrating the general principle, which is applicable also for larger values of N, e.g., for N>=128.

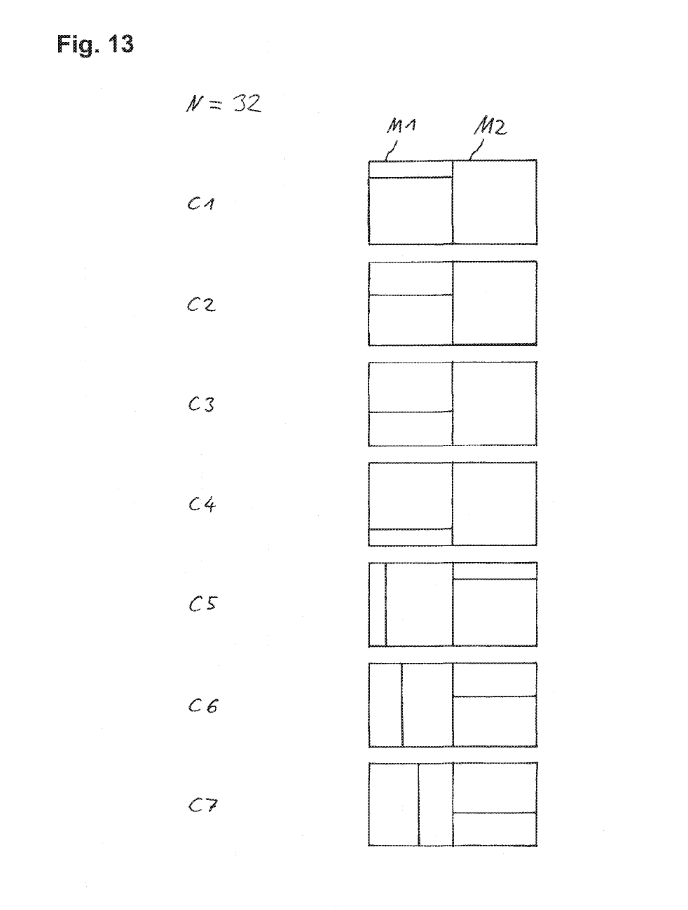

FIG. 13 illustrates an example of a scheme which may be principally the same as the one shown in FIG. 12 but in which N=32, P=4, and M=1. In this example, the operands are partitioned into two four-by-four matrices M1 and M2.

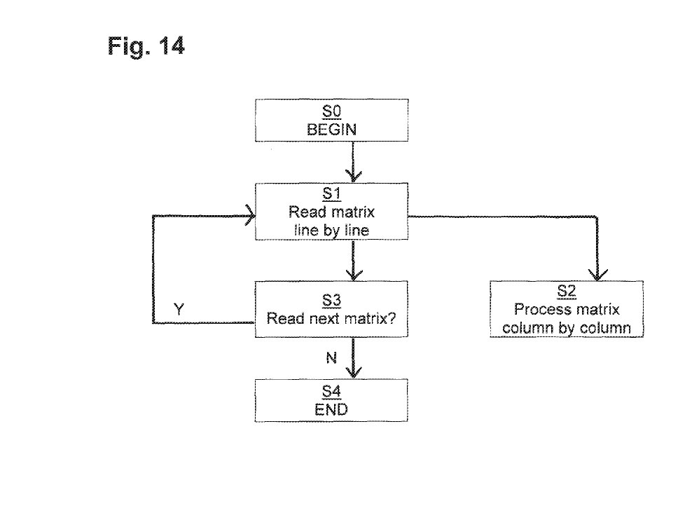

An example of performing a round of a FFT is described in reference to the flow chart shown in FIG. 14. The method may start in block S0. A set of N input operands may be provided in an input operand memory unit. The input operands may be thought of as a sequence of square matrices, each matrix having M*P lines and M*P columns. More specifically, the input operands may be arranged such that each column of each input operand matrix represents the input operands for the set of one or more butterflies to be effected in parallel. For example, now referring back to the example of a processing device shown in FIG. 11, each line of each input operand matrix may reside in an addressable location of the input operand memory unit 12. The input operands do not need to be addressable individually. The addressing scheme may therefore be relatively course, and the operand memory units may be less expensive than, e.g., operand memory units in which each operand is accessible individually.

Turning back to FIG. 14, each of the N/(M*P)̂2 input operand matrices may then be read line by line from the input operand memory unit (block S1). The respective matrix may then be processed column by column (block S2) to generate a transformed operand matrix (output operand matrix). If the round considered here is the final round of the FFT, the thus generated output operands constitute the final result, i.e., the Discrete Fourier Transform of the input operands of the first round of the FFT. Otherwise, the output operands of the current round may be used as the input operands of the next round of the FFT.

If the input operand matrix read in block S1 is not the last matrix of the above-mentioned sequence of input operand matrices, the operations of block S1 may be repeated for the next input operand matrix (blocks S1, S3). Otherwise, i.e., when the last input operand matrix has been read from the input operand memory unit and buffed and processed in block S2, the current round of the FFT may end (block S4). Block S2 for a certain matrix and block S1 for the next input operand matrix may be executed in parallel.

Referring now to FIG. 15, an example of a method of generating a read address for the input operand memory unit in a round of a FFT is illustrated by a self-explanatory flowchart. The input operand memory unit may, for example, comprise a Random Access Memory unit.

The self-explanatory flowchart shown in FIG. 16 further illustrates an example of a method of reading FFT input operands from the input operand memory unit and of buffering them in a buffer. In this example, N>=128, P=4, and M=2. Accordingly, the input operands may be partitioned into matrices of dimension 8*8. The input buffer may be equivalent to an 8*8 matrix of buffer locations (buffer cells). Each buffer location may be individually addressable. A buffer write direction may be defined as either horizontal (i.e., in the direction of lines) or vertical (i.e., in the direction of columns). Direction flips, i.e. horizontal to vertical and vice versa, may be performed whenever a complete input operand matrix has been buffered, i.e. after every eighth write operation in the example, considering that the lines of the input operand matrices are read one by one from the input operand memory unit and written one by one to the input buffer (in either the horizontal or vertical direction).

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on transitory or non-transitory computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the radix operation units 28 and 30 may be merged. The units 22 and 24 may be integrated in the control unit 26.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit (IC) or within a same device. For example, device 10 may be a single IC. Alternatively, the examples may be implemented as any number of separate integrated circuits or separate devices interconnected with each other in a suitable manner. For example, the units 12, 14, 16, 18, 20, 22, 24, 26, 28, and 30 may be dispersed across more than one IC.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A data processing device for performing a round of an N point Fast Fourier Transform, the data processing device comprising:
an input operand memory unit; and
an input buffer, wherein
the round comprises computing N output operands on the basis of N input operands by applying a set of N/P radix-P butterflies to the N input operands, wherein P is greater or equal two and the input operands are representable as a set of N/(M*P)̂2 input operand matrices (M1, M2), wherein M is greater or equal one, each input operand matrix is a square matrix with M*P lines and M*P columns, and each column of each input operand matrix contains the input operands for M of said butterflies, the data processing device is arranged to compute, for each of said input operand matrices, a corresponding output operand matrix by:
reading the respective input operand matrix from the input operand memory unit and buffering it as a whole in the input buffer, and
for each column of the buffered input operand matrix, computing the corresponding column of the output operand matrix by applying the respective M butterflies to the respective column.

2. The device of claim 1 configured to perform said reading of the respective input operand matrix from the input operand memory unit by reading the respective input operand matrix line by line.

3. The device of claim 2 configured to perform said reading of the respective input operand matrix from the input operand memory unit line by line by
reading the lines of the respective input operand matrix in M*P successive clock cycles,
and wherein said computing of the corresponding column of the output operand matrix comprises:
computing the corresponding column in a single clock cycle.

4. The device of claim 1 is arranged to store the M*P lines of each of said input operand matrices at contiguous addresses in the input operand memory unit.

5. The device of claim 1, wherein the input operand memory unit is a random-access memory unit.

6. The device of claim 1, arranged to read a current column of the buffered input operand matrix from the input buffer, apply the respective M butterflies to the current column, and write a line of a next input operand matrix to that region of the input buffer that is occupied by the current column of the buffered input operand matrix.

7. The device of claim 6, arranged to read said current column of the buffered input operand matrix from the input buffer within a single clock cycle and to write said line of said next input operand matrix to said region of the input buffer within the same clock cycle.

8. The device of claim 6, wherein the input buffer comprises a set of (M*P)̂2 individually addressable buffer cells, each cell being capable of buffering one input operand.

9. The device of claim 1, wherein the round is the first round of the Fast Fourier Transform.

10. The device of claim 1, implemented in a single integrated circuit.

11. A method for performing a round of a Fast Fourier Transform, the method comprising:
computing N output operands on the basis of N input operands by applying a set of N/P radix-P butterflies to the N input operands, wherein
P is greater or equal two, and
the input operands can be arranged in N/(M*P)̂2 input operand matrices,
M is greater or equal one,
each input operand matrix is a square matrix with M*P lines and M*P columns, and
each column of each input operand matrix contains the input operands for M of said butterflies; and
for each of said input operand matrices, computing a corresponding output operand matrix by:
reading the respective input operand matrix from an input operand memory unit and buffering it as a whole, and
for each column of the respective buffered input operand matrix, computing the corresponding column of the output operand matrix by applying M butterflies to the respective column.

12. The method of claim 11, wherein said reading of the respective input operand matrix from the input operand memory unit comprises:
reading the respective input operand matrix line by line.

13. The method of claim 11, wherein said reading of the respective input operand matrix from the input operand memory unit line by line comprises:
reading the lines of the respective input operand matrix in M*P successive clock cycles;
and wherein said computing of the corresponding column of the output operand matrix comprises:
computing the corresponding column in a single clock cycle.

14. The method of claim 11, comprising:
providing the M*P lines of each of said input operand matrices at contiguous addresses in the input operand memory.

15. The method of claim 11, comprising: reading a current column of the buffered input operand matrix from the input buffer, applying the respective M butterflies to the current column, and writing a line of a next input operand matrix to that region of the input buffer that is occupied by the current column of the buffered input operand matrix.
